(19) United States
(12) Patent Application Publication
(10) Pub. No.: US 2008/0112100 A1
(43) Pub. Date: May 15, 2008

(54) Digital electric leakage detecting and monitoring device

(76) Inventor: Daniel Liu, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/979,651

(22) Filed: Nov. 7, 2007

(30) Foreign Application Priority Data
Nov. 10, 2006 (TW) 95141728

(51) Int. Cl. H02H 3/16

(52) U.S. Cl. 361/45

(57) ABSTRACT

A digital electric leakage detecting and monitoring device includes a leakage current detection element connected to an AC power supply loop. When an outgoing current supplied from an AC line source to a load is not equal to a backflow current flowed from the load back to the AC line source, a leakage signal is generated by the leakage current detection element and sent to a microprocessor via a leakage signal processing circuit, so that the microprocessor generates a switch control signal to switch a switch unit from a close-circuit position to an open-circuit position and thereby cuts off the power supplied from the AC line source to the load. A switch status monitoring circuit is parallelly connected to the load for monitoring the switch status of the switch unit, and timely generating and sending a switch status signal to the microprocessor.

### FIELD OF THE INVENTION

The present invention relates to an AC line switch status monitoring device, and more particularly to a digital electric leakage detecting and monitoring device.

### BACKGROUND OF THE INVENTION

While electric power brings a lot of conveniences to people in their daily life, it also has potential dangers to people that should never be ignored. It is frequently reported people are electric shocked in using electric appliances. Therefore, it is an important issue to develop mechanisms for monitoring the AC line switch status and protecting people against injury caused by leakage current which may result from bad insulation or damaged electric appliances.

To effectively control normal and safe use of AC line source, various kinds of electronic devices have been developed for monitoring an AC line source, showing the status of AC line source, controlling the failure of AC line source, detecting leakage current, etc. For example, there is a currently commercially available power usage monitoring device connected to a load for calculating and showing conditions of the load in connection with the electric power, such as the voltage value, the current value, the power value, the frequency, the power factor, the elapsed time, and the cumulative KWH of the load. Most of the conventional leakage current detecting devices are of an analog hardware circuit, which comprises a zero-phase current transformer (ZCT) for detecting a leakage current and mechanically cuts off electric AC line supply if there is a leakage current.

The analog hardware circuit type AC line source monitoring devices have the disadvantages of high manufacturing cost, low mechanical accuracy, etc., and are therefore not safe and economical for use.

### SUMMARY OF THE INVENTION

A primary object of the present invention is to provide a digital electric leakage detecting and monitoring device for monitoring any leakage current in an AC line source loop, and timely cutting off the AC line source when an electric leakage is detected.

Another object of the present invention is to provide a detecting and monitoring device that has a switch status monitoring function and can therefore be used to monitor the switch statuses of the switches in a switch unit connected to an alternating current (AC) power supply loop, and generate at least one switch status signal based on the open circuit or close circuit status of the switches, and send the switch status signal to a microprocessor, the switch status monitoring circuit of the present invention can be used as a self diagnostic if the switch is in working condition or not. Furthermore, the alert signal will be indicated by the microprocessor if the device is in failure.

To achieve the objectives mentioned above, in accordance with the present invention, a digital electric leakage detecting and monitoring device includes a leakage current detection element connected to an AC line source loop. When an outgoing current supplied from an AC line source to a load is not equal to a backflow current from the load back to the AC line source, a leakage signal is generated by the leakage current detection element and sent to a microprocessor via a leakage signal processing circuit, so that the microprocessor generates a switch control signal to switch a switch unit from a close circuit position to an open circuit position and thereby cuts off the power supplied from the AC line source to the load. A switch status monitoring circuit is parallelly connected to the load for monitoring the switch status of the switch unit, and timely generating and sending a switch status signal to the microprocessor.

Compared to the prior art, the present invention provides a digital electric leakage detecting and monitoring device, which employs digital circuit technique to monitor any leakage current in an AC line source loop, so as to timely cut off the power supply in the event of detecting any leakage current in the AC line source loop. Moreover, the present invention includes a switch status monitoring circuit for monitoring the switch statuses of switches in a switch unit connected to an AC line source loop, and generating at least one switch status signal based on the open circuit or close circuit status of the switches, and sending the switch status signal to a microprocessor. The self diagnostic of the switch can be done by the switch status monitoring circuit of present invention. In the case an abnormal switch status is detected, the microprocessor sends a failure alert signal to the display unit to warn the user, and, therefore, the device safety can be achieved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a block diagram of a digital electric leakage detecting and monitoring device according to the present invention; and

FIG. 2 is a preferred embodiment of the circuit diagram for the digital electric leakage detecting and monitoring device of the present invention.

### DETAILED DESCRIPTION OF THE PREFERRED EMBODIMENTS

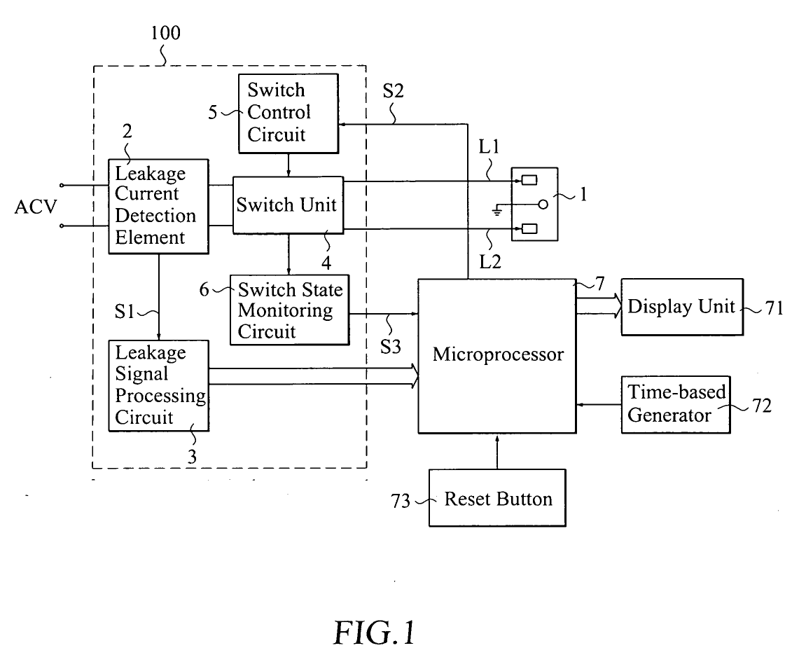

Please refer to FIG. 1 that is a block diagram of a digital electric leakage detecting and monitoring device 100 according to the present invention. As shown, the digital electric leakage detecting and monitoring device 100 is connected to an alternating current (AC) power supply loop consisting of an AC line source ACV and a load 1. The AC power supply loop includes a first power cord L1 and a second power cord L2 for supplying electric power from the AC line source ACV to the load 1.

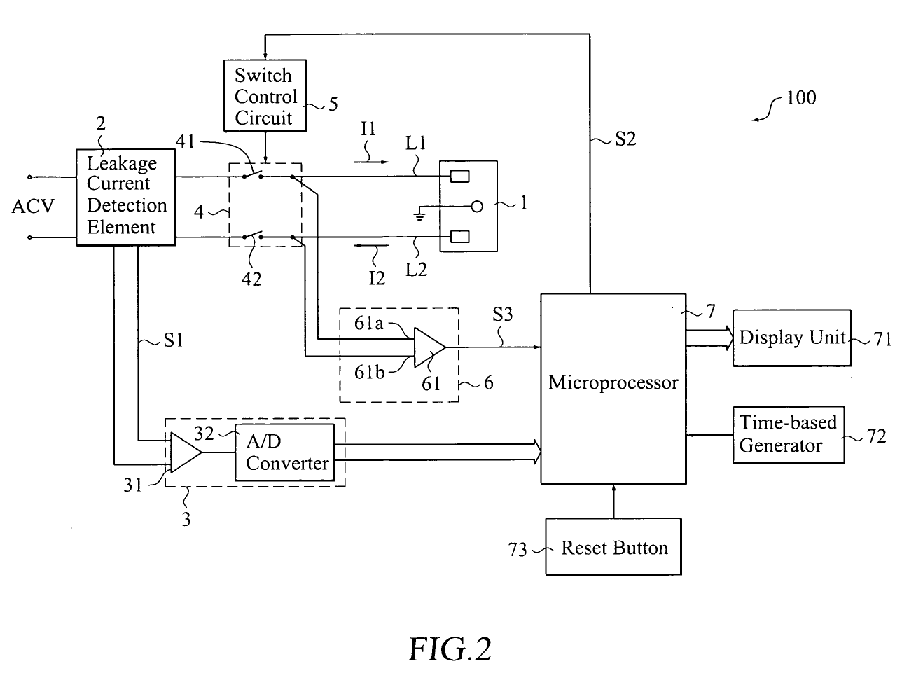

Please also refer to FIG. 2 that is a preferred embodiment of the circuit diagram for the digital electric leakage detecting and monitoring device 100. As shown, the digital electric leakage detecting and monitoring device 100 includes a leakage current detection element 2, a leakage signal processing circuit 3, a switch unit 4, a switch control circuit 5, a switch status monitoring circuit 6, and a microprocessor 7.

The leakage current detection element 2 may comprise a conventional zero-phase current transformer (ZCT), and is coupled to the first power cord L1 and the second power cord L2 for detecting a leakage current of the AC power supply loop. When an outgoing current I1 supplied from the AC line source ACV via the first power cord L1 to the load 1 is not equal to a backflow current I2 from the load 1 via the second power cord L2 back to the AC line source ACV, a leakage signal S1 is generated at an output of the leakage current detection element 2. The leakage signal S1 is processed at the leakage signal processing circuit 3 and then sent to the microprocessor 7.

The leakage signal processing circuit 3 includes a signal amplifier 31, which has two inputs being parallelly connected to the output of the leakage current detection element 2 for amplifying the leakage signal S1 generated by the leakage current detection element 2, and an analog-to-digital converter (A/D converter) 32 for converting the leakage signal S1 amplified by the signal amplifier 31 into a digital leakage signal and sending the leakage signal to the microprocessor 7.

The switch unit 4 includes a first switch 41 and a second switch 42, which are connected in series to the first power cord L1 and the second power cord L2, respectively. The first and the second switch 41, 42 are controlled by the switch control circuit 5 based on a switch control signal S2 generated by the microprocessor 7.

The switch status monitoring circuit 6 is connected to the load 1 in parallel for monitoring the switch status of the first and second switches 41, 42 of the switch unit 4, and generates a switch status signal S3 based on the open-circuit or close-circuit status of the first and second switches 41, 42. The switch status signal S3 is then sent to the microprocessor 7. The switch status signal S3 is a square pulse waveform of line frequency or a logic low level signal.

The switch status monitoring circuit 6 includes a comparator 61, which has a first input 61a and a second input 61b respectively connected to the first power cord L1 and the second power cord L2 of the load 1 in parallel and an output connected to the microprocessor 7, so as to detect the status of voltage supplied to the load 1.

When both the first and the second switch 41, 42 are closed, the output of the switch status monitoring circuit 6 is at square pulse waveform of line frequency to represent there is an output, which indicates the two switches 41, 42 are in a normal switch status. When both the first and the second switch 41, 42 are in open circuit, the output of the switch status monitoring circuit 6 is at low level status to represent there is no output, which also indicates the two switches 41, 42 are in a normal switch status. Any switch status other than these two statuses indicates at least one of the two switches 41, 42 is in an abnormal switch status. At this point, the switch status monitoring circuit 6 would generate a switch status signal S3, which would be detected by the microprocessor 7.

When the first and second switches 41, 42 of the switch unit 4 are closed and the microprocessor 7 detects a leakage signal S1 generated by the leakage current detection element 2, the microprocessor 7 compares the leakage signal S1 with a preset leakage current value. When the leakage signal S1 indicates a leakage current value larger than the preset leakage current value, the microprocessor 7 generates and sends a switch control signal S2 to the switch unit 4, so that the first and the second switch 41, 42 of the switch unit 4 are switched to open and thereby cut off the electric power supplied from the AC line source ACV to the load 1.

The microprocessor 7 is connected to a display unit 71, a time-based generator 72, and a reset button 73. The display unit 71 displays the operating status signals and the switch statuses of the switches of the switch unit 4. The time-based generator 72 is able to provide a time-based signal to the microprocessor 7. The reset button 73 is used to turn on the switch unit 4 after leakage alert is tripped. When the microprocessor 7 receives the leakage signal S1 generated by the leakage current detection element 2 and thereby controls the first and second switches 41, 42 of the switch unit 4 to switch from a close position to an open position, the reset button 73 may be used to reset the switch unit 4, so that the switch unit 4 is switched from the open position to the close position again.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A digital type electric leakage detecting and monitoring device connected to an AC power supply loop having a first power cord and a second power cord for supplying electric power from an AC line source to a load, comprising:
a microprocessor;
a leakage current detection element coupled to the first power cord and the second power cord for detecting a leakage current of the AC line supply loop, such that when an outgoing current supplied from the AC line source via the first power cord to the load is not equal to a backflow current flowed from the load via the second power cord back to the AC line source, a leakage signal is generated at an output of the leakage current detection element;
a leakage signal processing circuit connected to the leakage current detection element and the microprocessor for processing the leakage signal generated by the leakage current detection element and sending the processed leakage signal to the microprocessor; and
a switch unit connected to and between the AC line source and the load, and being able to switch between a close position and an open position;
whereby when the switch unit is in the close position and the microprocessor receives the leakage signal generated by the leakage current detection element, the microprocessor generates and sends a switch control signal to the switch unit, so that the switch unit is switched from the close position to the open position to thereby cut off the electric power supplied from the AC line source to the load.

2. The digital type electric leakage detecting and monitoring device as claimed in claim 1, wherein the leakage signal processing circuit includes a signal amplifier, which has two inputs being connected in parallel to the output of the leakage current detection element for amplifying the leakage signal generated by the leakage current detection element, and an analog-to-digital converter for converting the leakage signal amplified by the signal amplifier into a digital leakage signal and sending the leakage signal to the microprocessor.

3. The digital type electric leakage detecting and monitoring device as claimed in claim 1, further comprising a reset button which is used to restore the switch unit from the open position to the close position after the switch unit is tripped from the close position to the open position by electric leakage current.

4. The digital type electric leakage detecting and monitoring device as claimed in claim 1, further comprising a switch status monitoring circuit, the switch status monitoring circuit having a first and a second input connected in parallel to the load for monitoring open and close status of the switches in the switch unit, generating a switch status signal based on the open and close status of the switches, and sending the switch status signal to the microprocessor.

5. The digital type electric leakage detecting and monitoring device as claimed in claim 4, wherein the switch status monitoring circuit further includes a comparator, which has a first and a second input connected in parallel to the load and an output connected to the microprocessor so as to detect a status of voltage supplied to the load.
